(19) United States
(12) Patent Application Publication
(10) Pub. No.: US 2014/0250438 A1
(43) Pub. Date: Sep. 4, 2014

(54) SCHEDULING METHOD IN MULTIPROCESSOR APPARATUS AND METHOD OF ASSIGNING PRIORITIES TO TASKS USING PSEUDO-DEADLINES IN MULTIPROCESSOR APPARATUS

(71) Applicant: Korea Advanced Institute of Science and Technology, Daejeon (KR)

(72) Inventors: In-Sik SHIN, Daejeon (KR); Hyeong-Boo Baek, Daejeon (KR); Hoon-sung Shwa, Busan (KR)

(73) Assignee: Korea Advanced Institute of Science and Technology, Daejeon (KR)

(21) Appl. No.: 14/065,526

(22) Filed: Oct. 29, 2013

(30) Foreign Application Priority Data
Mar. 4, 2013 (KR) 10-2013-0022849

(51) Int. Cl. G06F 9/48

(52) U.S. Cl. CPC G06F 9/4887
USPC 718/103

(57) ABSTRACT

Provided are a scheduling method in a multiprocessor apparatus and a method of assigning priorities to tasks using pseudo-deadlines in a multiprocessor apparatus. The scheduling method includes releasing tasks (510), setting relative pseudo-deadlines for the tasks such that jobs belonging to one task τₐ among the tasks always have higher priorities than jobs belonging to another task τ_{b}, and determining task priorities (520), and setting absolute pseudo-deadlines for jobs belonging to the tasks, and determining job priorities (530).

### CROSS-REFERENCE TO RELATED APPLICATION

This application claims priority to and the benefit under 35 U.S.C. §119(a) of Korean Patent Application No. 2013-0022849, filed on Mar. 4, 2013, in the Korean Intellectual Property Office, the entire disclosure of which is incorporated herein by reference for all purpose.

### BACKGROUND

1. Field

The following description relates to a scheduling method of assigning priorities to tasks or jobs in an apparatus having a multiprocessor, and more particularly, to a scheduling method in a multiprocessor apparatus and a method of assigning priorities to tasks using pseudo-deadlines in a multiprocessor apparatus.

This invention was supported by the IT R&D program of MSIP (Ministry of Science, ICT and Future Planning) and KEIT (Korea Evaluation Institute of Industrial Technology) in Korea [10041313, UX-oriented Mobile SW Platform].

2. Discussion of Related Art

A real-time embedded multi-core system is widely used, and thus research into a real-time embedded system is intensively ongoing. To respective real-time tasks each of which consecutively releases real-time jobs in a real-time system, a real-time scheduling algorithm assigns priorities, and performs scheduling on the basis of the assigned priorities. Research into such a real-time system is typically carried out in two respects. One is a real-time scheduling algorithm that is aimed not to miss a deadline by effectively assigning priorities to real-time tasks and real-time jobs, and a real-time property (schedulability) analysis technique that is aimed to analyze whether the system will not miss the deadline when the real-time tasks and the real-time jobs are scheduled on the basis of the assigned priorities.

Real-time scheduling algorithms based on priorities have two typical types of scheduling algorithms. They are a Task-level Fixed-Priority (TFP) scheduling algorithm of performing scheduling by assigning priorities to real-time tasks, and a Job-level Fixed Priority (JFP) scheduling algorithm of performing scheduling by assigning priorities to real-time jobs that are subordinate to real-time tasks. According to definitions of the two types of scheduling algorithms, the JFP scheduling algorithm is a generalized TFP scheduling algorithm and capable of more detailed priority assignment.

While active research has been carried out into the TFP scheduling algorithm and a real-time property analysis technique supporting the TFP scheduling algorithm (see B/ Andersson, S. Baruah, and J. Jonsson, “Static-priority scheduling on multiprocessors,” in RTSS, 2001. etc.), very little research has been carried out into the JFP scheduling algorithm. Although the JFP scheduling algorithm is a generalized TFP scheduling algorithm, it is impossible to apply strong real-time property analysis techniques that are highly accurate and support the TFP scheduling algorithm to the JFP scheduling algorithm. This is because such strong techniques were initially designed appropriate for TFP scheduling only, and there is no method of effectively assigning priorities to respective jobs that makes it possible to apply the strong techniques to JFP scheduling.

However, much research was carried out into Job-level Dynamic Priority (JDP) at a job level (see G. Levin, S. Funk, C. Sadowski, I. Pye, and S. A. Brandt, “Dp-fair: A simple model for understanding optimal multiprocessor scheduling,” in ECRTS, 2010. etc.).

### SUMMARY

In one general aspect, there is provided a scheduling method in a multiprocessor apparatus including: releasing tasks; setting relative pseudo-deadlines for the tasks such that jobs belonging to one task τₐ among the tasks always have higher priorities than jobs belonging to another task τ_{b}, and determining task priorities; and setting absolute pseudo-deadlines for jobs belonging to the tasks, and determining job priorities.

The determining of the task priorities may include setting the relative pseudo-deadlines such that τₐ and τ_{b} satisfy Pₐ≦P_{b}−D_{b}. Here, Pₐ is a relative pseudo-deadline for τₐ, P_{b} is a relative pseudo-deadline for τ_{b}, and D_{b} is a relative deadline for τ_{b}.

The relative pseudo-deadlines may be intervals between times at which the jobs belonging to the tasks are released and the absolute pseudo-deadlines for the jobs, and the relative deadline may be an interval between a time at which one job is released and an absolute deadline for the job.

The determining of the job priorities may include calculating an absolute pseudo-deadline pᵢ^{h} of an h^{th} job for a task as pᵢ^{h}=rᵢ^{h}+Pᵢ, and assigning a highest priority to a job having a smallest pᵢ^{h}. Here, rᵢ^{h} is a time at which Jᵢ^{h} is released, and Pᵢ is a relative deadline for τᵢ.

In the determining of the task priorities, τᵢ and τₖ that are different tasks among the tasks may satisfy an interference condition of an expression below on a multiprocessor including m identical processors.

$$\text{?} {I}_{i , k}^{SPDF} < m \cdot ( {D}_{k} - {C}_{k} + 1 )$$

$$\text{?} \text{indicates text missing or illegible when filed}$$

where I_{i,k}^{SPDF} is interference between the tasks τᵢ and τₖ, Dₖ is a relative deadline for the task τₖ, and Cₖ is a worst-case execution time of the task τₖ.

In another general aspect, there is provided a method of assigning priorities to tasks using pseudo-deadlines in a multiprocessor apparatus including: in a k^{th} step, dividing a task set into a subset A(k) assigned priorities and a subset R(k) to be assigned priorities after the k^{th} step; determining a subset S(k) for setting a pseudo-deadline from R(K); and setting a pseudo-deadline for S(k), and assigning the priorities.

A task τₐ belonging to A(k) and a task τᵣ belonging to R(k) may satisfy Pₐ≦Pᵣ−Dᵣ such that jobs belonging to τₐ may have higher priorities than jobs belonging to τᵣ. Here, Pₐ is a relative pseudo-deadline for τₐ, Pᵣ is a relative pseudo-deadline for τᵣ, and Dᵣ is a relative deadline for τᵣ.

The determining of S(k) may include examining all combinations of tasks belonging to R(k), and determining S(k) such that all jobs of tasks belonging to S(k) have higher priorities than jobs of tasks belonging to A(k), and the jobs of the tasks belonging to S(k) have lower priorities than jobs of tasks remaining in R(k).

A buffer zone [Z^{H}(k), Z^{L}(k)] may be in a time period between A(k) and R(k), and no pseudo-deadline may be assigned in the buffer zone.

In the determining of S(k), τᵢ and τₖ that are different tasks among tasks belonging to S(k) may satisfy an interference condition of an expression below on a multiprocessor including m identical processors.

$$\text{?} {I}_{i , k}^{SPDF} < m \cdot ( {D}_{k} - {C}_{k} + 1 )$$

$$\text{?} \text{indicates text missing or illegible when filed}$$

where I_{i,k}^{SPDF} is interference between the tasks τᵢ and τₖ, Dₖ is a relative deadline for the task τₖ, and Cₖ is a worst-case execution time of the task τₖ.

Other features and aspects may be apparent from the following detailed description, the drawings, and the claims.

### BRIEF DESCRIPTION OF THE DRAWINGS

FIG. 1 is an example of a schematic flowchart of a scheduling method in a multiprocessor apparatus;

FIG. 2 is a diagram illustrating that two tasks τₐ and τ_{b} have the relationship of τₐ [symbol] τ_{b} only when the two tasks τₐ and τ_{b} satisfy the condition of Pₐ≦P_{b}−D_{b};

FIG. 3 illustrates an example of a relationship between two task sets τ′ and τ″ and a relationship between tasks τᵢ and τⱼ belonging to each task set;

FIG. 4 is an example illustrating an example of worst-case patterns for different cases in interference-based analysis for a Smallest Pseudo-Deadline First (SPDF) technique;

FIG. 5 is an example of a flowchart of a method of assigning priority to tasks using pseudo-deadlines in a multiprocessor apparatus; and

FIG. 6 illustrates an example of a buffer zone in a k^{th} step of optimal pseudo-deadline assignment (OPDA).

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Before starting detailed explanations of figures, separation of components in this specification are merely in accordance with functions mainly performed by the respective components. That is, two or more components which will be described below can be integrated into a single component, or a single component can be divided and provided as two or more components according to subdivided functions. Moreover, each component which will be described below can additionally perform some or all of functions executed by another component in addition to the main function thereof. Some or all of the main functions of each component can be carried out by another component.

In some alternative implementations of a method or an operation method, respective processes constituting the method may occur out of a specified order unless the context clearly indicates a specific order. That is, the respective processes can occur in the same order as specified, at the substantially same time, or in the reverse order.

Hereinafter, the present invention will be described in detail with reference to the accompanying drawings.

The present invention will be understood in further detail with reference to the paper “Extending Task-level to Job-level Fixed Priority Assignment and Schedulability Analysis Using Pseudo-deadlines” (2012 IEEE 33^{rd} Real-time Systems Symposium, December 2012) written by the inventor. Content that is not described in this specification may be found in the paper.

The present invention relates to a global scheduling technique used in a multiprocessor platform including m identical processors. Prior to the detailed description of the present invention, a system model, terminology, etc. used in the description will be checked.

The present invention is based on a task model τ that does not keep existing but occurs intermittently. Here, a task τᵢ (τᵢετ) may be consecutive jobs that can be potentially infinitely performed. The task model of the present invention has a limitation of ∀ᵢ, Cᵢ≦Dᵢ≦Tᵢ, and one job cannot be performed in parallel. Here, Tᵢ denotes a minimum inter-job separation, Cᵢ denotes a worst-case execution time, and Dᵢ denotes a relative deadline.

The density of a task is defined as δᵢ=Cᵢ/Dᵢ, and a system density is defined as δ_{sys}=Σ_{T}_{ᵢ}_{εT}δᵢ. Jᵢ^{h} is termed an h^{th} job of the task τᵢ below, and rᵢ^{h} and dᵢ^{h} are termed a release time at which the h^{th} job is released from the task τᵢ and an absolute deadline below, respectively. dᵢ^{h} is calculated as dᵢ^{h}=rᵢ^{h}+Dᵢ. A scheduling window of the job Jᵢ^{h} is defined as an interval (rᵢ^{h},dᵢ^{h}). When two jobs and Jᵢ^{h} overlap the same scheduling window, they are referred to as being in competition with each other.

A scheduling algorithm described in the present invention is termed Smallest Pseudo-Deadline First (SPDF). Each task τᵢ has a task-level parameter referred to as a relative pseudo-deadline Pᵢ.

The Jᵢ^{h} job has an absolute pseudo-deadline pᵢ^{h}. pᵢ^{h} is determined as pᵢ^{h}=rᵢ^{h}+Pᵢ. In the description of the present invention, a pseudo-deadline is assumed to have a value of a natural number. According to the SPDF algorithm, the highest priority is assigned to a job having the least pᵢ^{h}. SPDF is a Job-level Fixed Priority (JFP) scheduling algorithm, and is very similar to the classic Earliest Deadline First (EDF) algorithm except that SPDF uses pseudo-deadlines instead of actual deadlines. Pseudo-deadlines are variables used for prioritizing jobs without actually changing job characteristics.

SPDF Scheduling Algorithm

First, a priority relationship is defined between tasks. When there is a pair of tasks τᵢ and τₖ, it is possible to define priority relationships as described below.

Type A: When all jobs of the task τᵢ have higher priorities than jobs of the competitive task τₖ, the task τᵢ is said to be “strictly higher” than the other task τₖ, and denoted by τᵢ [symbol] τₖ. The relationship of τᵢ [symbol] τₖ between the task pair is termed Type A1, and the relationship of τᵢ [symbol] τₖ is termed Type A2.

Type B: When some jobs of the task τᵢ have higher priorities than jobs of the competitive task τₖ, and the other jobs of the task τᵢ have lower priorities than the jobs of the competitive task τₖ, the two tasks τᵢ and τₖ are said to be “mutual,” and denoted by τᵢ [symbol] τₖ.

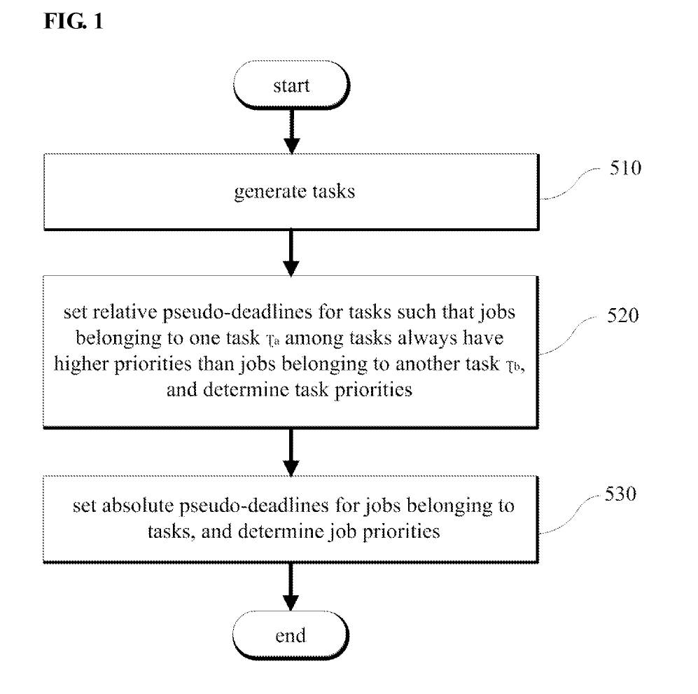

FIG. 1 is an example of a schematic flowchart of a scheduling method in a multiprocessor apparatus.

A scheduling method in a multiprocessor apparatus includes releasing tasks (510), setting relative pseudo-deadlines for tasks such that jobs belonging to one task τₐ among the tasks always have higher priorities than jobs belonging to another task τ_{b}, and determining task priorities (520), and setting absolute pseudo-deadlines for jobs belonging to the tasks, and determining job priorities (530).

A lemma of the SPDF algorithm of the present invention and a proof of the lemma will be described below.

Lemma 1: Only when two tasks τₐ and τ_{b} satisfy the condition of Pₐ≦P_{b} D_{b}, the two tasks have the relationship of τₐ [symbol] τ_{b}. A proof of Lemma 1 is provided in the paper “Extending Task-level to Job-level Fixed Priority Assignment and Schedulability Analysis Using Pseudo-deadlines” written by the inventor.

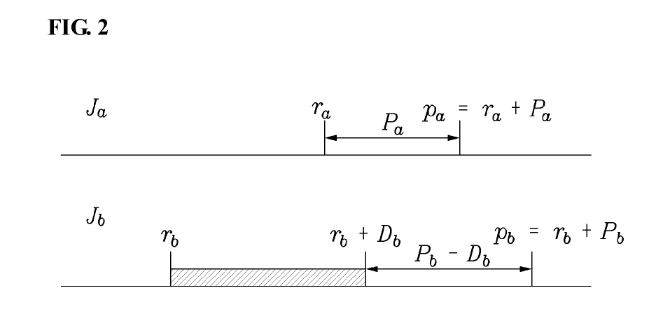

FIG. 2 illustrates that two tasks τₐ and τ_{b} have the relationship of τₐ [symbol] τ_{b} only when the two tasks τₐ and τ_{b} satisfy the condition of Pₐ≦P_{b}−D_{b}. Jₓ denotes any one job of a task τₓ. Lemma 1 shows that, when Pₐ≦P_{b}−D_{b} holds for any task set, SPDF maintains the priority order of τₐ [symbol] τ_{b}.

Theorem 1: The SPDF algorithm is better than all Task-level Fixed-Priority (TFP) algorithms, EDF, EDF-Utilization-Separation (US), and fully-preemptive (fp)-EDF. A proof of this is provided in the paper “Extending Task-level to Job-level Fixed Priority Assignment and Schedulability Analysis Using Pseudo-deadlines” written by the inventor.

SPDF Schedulability Analysis

Schedulability of SPDF proposed in the present invention will be analyzed. First, interference-based analysis that is used as a basic tool for schedulability conditions of various algorithms, such as EDF, TFP, etc., will be described in brief, and also, a Deadline Analysis with Limited Carry-in (DA-LC) technique that improves the performance of interference-based analysis will be described. Lastly, it will be described how interference-based analysis is applied to the SPDF algorithm of the present invention.

1) Interference-based analysis: The total interference on a task τₖ in an interval [a,b) is the cumulative length of all intervals in which the task τₖ can be executed but is not executed due to jobs having higher priorities. Here, the total interference is denoted by Īₖ(a,b).

Interference Ī_{i,k}(a,b) of a task τᵢ on the task τₖ in the interval [a,b) is the cumulative length of all intervals in which the task τₖ can be executed but is not executed because τᵢ is being executed. Since a task cannot be scheduled when m other tasks are executed, the relationship between Īₖ(a,b) and Ī_{i,k}(a,b) is derived from Lemma 3 provided in the paper (M. Bertogna, M. Cirinei, and G. Lipari, “Improved schedulability analysis of EDF on multiprocessor platforms,” in ECRTS, 2005.) written by M. Bertogna et al., and is given as Expression 1 below.

$${\overline{I}}_{k} ( a , b ) = \frac{{\sum }_{i \neq k}^{ } {\overline{I}}_{i , k} ( a , b )}{m} \qquad [ Expression 1 ]$$

Jₖ* denotes a job encountering the most total interference among jobs of τₖ, and a worst total interference Iₖ* of the jobs of τₖ is given as Expression 2 below.

$${I}_{k}^{*} {=}^{Δ} {max}_{h} ( {\overline{I}}_{k} ( {r}_{k}^{h} , {d}_{k}^{h} ) ) = {\overline{I}}_{k} ( {r}_{k}^{*} , {d}_{k}^{*} ) \qquad [ Expression 2 ]$$

For the convenience of notation, Expression 2 is defined as Expression 3 below.

I_{i,k}* [symbol] Ī_{i,k}(rₖ*,dₖ*) [Expression 3]

Using the above definition, existing research was carried out into an accurate schedulability condition of global multiprocessor scheduling algorithms (see M. Bertogna, M. Cirinei, and G. Lipari, “Improved schedulability analysis of EDF on multiprocessor platforms,” in ECRTS, 2005. and M. Bertogna, M. Cirinei, and G. Lipari, “Schedulability analysis of global scheduling algorithms on multiprocessor platforms,” IEEE Transactions on Parallel and Distributed Systems, vol. 20, pp. 553-566, 2009.). The content is the same as Lemma 2 below.

Lemma 2: A task set τ is schedulable on a multiprocessor having m identical processors only when a condition of Expression 4 below holds for every task τₖ.

$$\text{?} min ( {I}_{i , k}^{*} , {D}_{k} - {C}_{k} + 1 ) < m \cdot ( {D}_{k} - {C}_{k} + 1 ) \\ \text{?} \text{indicates text missing or illegible when filed} \qquad [ Expression 4 ]$$

Since it is difficult to accurately calculate I_{i,k}*, existing approaches derive an upper bound of I_{i,k}* (see T. P. Baker, “Multiprocessor EDF and deadline monotonic schedulability analysis,” in RTSS, 2003. etc.).

2) DA-LC analysis technique: A job that is released in advance of a specific interval and has a deadline in the interval is referred to as a carry-in job. The DA-LC analysis technique has been introduced to calculate the maximum interference of carry-in jobs. The DA-LC technique was developed for initial EDF. After that, the DA-LC technique has been researched for the TFP scheduling algorithm.

3) Interference-based analysis under SPDF: As described above, priority relationships between jobs are classified into A1, A2, and B. In terms of a relationship with τₖ, each task τᵢ (≠τₖ) belongs to one of three sets, τₖ^{(A1)}, τₖ^{(A2)}, and τₖ^{(B)}. τₖ belongs to τₖ^{(A1)} when τᵢ [symbol] τₖ, τₖ belongs to τₖ^{(A2)} when τᵢ [symbol] τₖ, and τₖ belongs to τₖ^{(B)} when τᵢ [symbol] τₖ.

Type A1. First, an upper bound of I_{i,k}* will be derived in case of Type A1. In general, the DA-LC technique is applied to TFP having Type A relationship. Thus, it will be examined whether it is possible to use DA-LC analysis for tasks having Type A relationship in the SPDF scheduling technique.

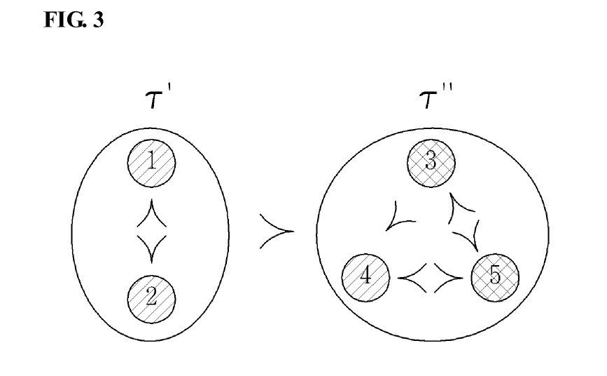

FIG. 3 illustrates an example of a relationship between two task sets τ′ and τ″ and a relationship between tasks τᵢ and τⱼ belonging to each task set. When the task sets τ′ and τ″ have the relationship of τ′ [symbol] τ″, τᵢ [symbol] τⱼ holds for a task τᵢετ′ and a task τⱼετ″. In FIG. 3, τ₁ and τ₂ are strictly higher than τ₃, τ₄, and τ₅ (Type A1).

τ is divided into two disjoint subsets τₖ^{(A*)} and τₖ^{(B*)}. From the standpoint of τₖ, τₖ^{(B*)} should include τₖ, and τₖ^{(A*)} [symbol] τₖ^{(B*)}. This relationship is defined as τₖ^{(A*)}⊂τₖ^{(B*)}, and there is a high probability of τₖ^{(A*)} having better schedulability.

A certain task τ_{b}ετₖ^{(B*)} released earlier can be changed in priority between only tasks belonging to τₖ^{(B*)}. However, a change in the priority of τ_{b} does not result in a change in the priority relationship between τₖ^{(A*)} and τₖ^{(B*)}. Lemma 3 below shows that the DA-LC technique applied to TFP can be applied to τₖ^{(A*)}.

Lemma 3: Under SPDF, the amount of execution of jobs of tasks belonging to τₖ^{(A*)} in an interval of a length l is maximized when there are at most m−1 carry-in jobs of tasks belonging to τₖ^{(A*)}. A proof of Lemma 3 is provided in the paper “Extending Task-level to Job-level Fixed Priority Assignment and Schedulability Analysis Using Pseudo-deadlines” written by the inventor.

In order to apply the DA-LC technique that is applied to TFP to SPDF also, two sub-cases are necessary to be considered for calculation of I_{i,k}*.

When τᵢετₖ^{(A1)} has a carry-in job in an interval between the release time and a deadline for τₖ, the upper bound of I_{i,k}* is determined by the maximum execution time of jobs of τₖ in an interval having a length of Dₖ. When the length of the interval is generalized as l, Expression 5 below is obtained.

$$\text{?} ( l ) = ⌊ \frac{l + {D}_{i} - {C}_{i}}{\text{?}} ⌋ \cdot {C}_{i} + min ( \text{?} ( l + {D}_{i} - {C}_{i} ) mod {T}_{i} ) \\ \text{?} \text{indicates text missing or illegible when filed} \qquad [ Expression 5 ]$$

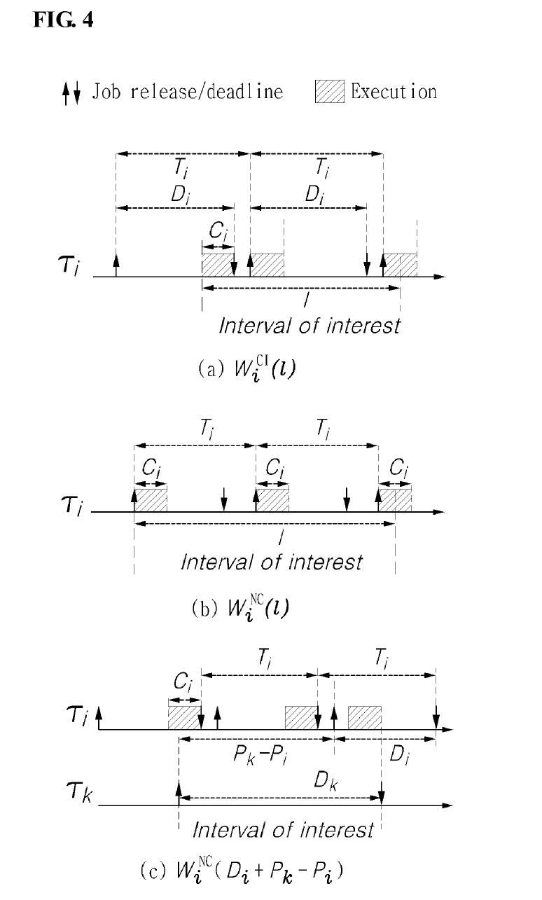

FIG. 4 is an example illustrating worst-case patterns for different cases in interference-based analysis for the SPDF technique.

When the first job of a task τᵢ is executed as late as possible, the upper bound is determined by the maximum execution time. As shown in FIG. 4(a), other jobs are scheduled immediately thereafter.

On the other hand, when τᵢετₖ^{(A1)} has no carry-in job in the interval, the upper bound Wᵢ^{NC}(Dₖ) of I_{i,k}* is determined by the maximum execution time of non-carry-in jobs among jobs of τᵢ in an interval having a length of Dₖ. When the length of the interval is generalized as l, Expression 6 below is obtained.

$${W}_{i}^{NC} ( l ) = ⌊ \frac{l}{{T}_{i}} ⌋ \cdot {C}_{i} + min ( {C}_{i} , l mod {T}_{i} ) \qquad [ Expression 6 ]$$

In this case, all jobs are released and scheduled as soon as possible as shown in FIG. 4(b). Wᵢ^{CI}(l)≧Wᵢ^{NC}(l) holds for the length l greater than 0.

Type A2. In case of Type A2, τₖ has on interference from τᵢ, and thus I_{i,k}* is 0.

Type B. An upper bound of I_{i,k}* will be derived when τᵢ belongs to τₖ^{(B)}. When Jᵢ^{g} of τᵢετₖ^{(B)} interferes with Jₖ^{h} (when Jᵢ^{g} has a higher priority than Jₖ^{h}), rᵢ^{g}+Pᵢ≦rₖ^{h}+Pₖ is satisfied. Thus, the execution time of jobs of τᵢ having higher priorities than jobs of τₖ is maximized when a pseudo-deadline for a job of τᵢ is the same as that of a job of τₖ. In other words, the release times of a job of τᵢ and a job of τₖ are spaced apart by Pₖ−Pᵢ as shown in FIG. 4(c).

At this time, the upper bound of I_{i,k}* is determined as Wᵢ^{NC}(Dᵢ+Pₖ−Pᵢ), Since the upper bound should not be larger than Wᵢ^{CI}(Dₖ), smaller one of the two upper bounds is used for I_{i,k}*.

Details of the upper bound of I_{i,k}* is summarized now. For the schedulability test of PDF, Expression 4 described above has been used. Under SPDF, an upper bound of I_{i,k}* is given as Expression 7 below.

$${I}_{i , k}^{SPDF} {=}^{Δ} min ( {I}_{i , k}^{*} , {D}_{k} - {C}_{k} + 1 ) under SPDF \leq \{ \begin{matrix}{I}_{i , k}^{( A 2 )} {=}^{Δ} 0 , if {P}_{k} - {P}_{i} \leq - {D}_{i} ( i . e . , Type A 2 ) , \\ {I}_{i , k}^{( A 1 )} {=}^{Δ} min ( {W}_{i}^{C 1} ( {D}_{k} ) , {D}_{k} - {C}_{k} + 1 ) , \\ if {P}_{k} - {P}_{i} \geq {D}_{k} ( i . e . , Type A 1 ) \& with carry \text{-} in \\ {\hat{I}}_{i , k}^{( A 1 )} {=}^{Δ} min ( {W}_{i}^{NC} ( {D}_{k} ) , {D}_{k} - {C}_{k} + 1 ) , \\ if {P}_{k} - {P}_{i} \geq {D}_{k} ( i . e . , Type A 1 ) \& no carry \text{-} in \\ {I}_{i , k}^{( B )} {=}^{Δ} min ( {W}_{i}^{NC} ( {D}_{i} + {P}_{k} - {P}_{i} ) , {W}_{i}^{C 1} ( {D}_{k} ) , {D}_{k} - {C}_{k} + 1 ) , \\ if - {D}_{i} < {P}_{k} - {P}_{i} < {D}_{k} ( i . e . , Type B )\end{matrix} \qquad [ Expression 7 ]$$

Since I_{i,k}^{(A1)}≧I_{i,k}^{(A1)} holds, a safe schedulability test of SPDF may be derived for τᵢετₖ^{(A1)} using as an upper bound of min(I_{i,k}*, Dᵢ−Cₖ+1).

Consequently, in view of Expression 7 and Lemma 3 described above, a schedulability test of SPDF may be derived using Theorem 2 below.

Theorem 2: A task set τ can be scheduled under SPDF with given priority assignment {Pᵢ}_{T}_{ᵢ}_{εT}. on a multiprocessor having m identical processors when each task τₖ satisfies the condition of Expression 8 below.

$${\sum }_{{τ}_{i} ∈ τ \backslash \{ {τ}_{k} \}}^{ } {I}_{i , k}^{SPDF} < m \cdot ( {D}_{k} - {C}_{k} + 1 ) \qquad [ Expression 8 ]$$

An upper bound of the left-hand side of Expression 8 is determined according to Expression 9 below. A detailed proof of this is provided in the paper “Extending Task-level to Job-level Fixed Priority Assignment and Schedulability Analysis Using Pseudo-deadlines” written by the inventor.

$$\text{?} + \text{?} ( {I}_{i , k}^{( A 1 )} - {\hat{I}}_{i , k}^{( A 1 )} ) + \text{?} {I}_{i , k}^{( A 1 )} + {\sum }_{{τ}_{i} ∈ {τ}_{k}^{( B )}}^{ } {I}_{i , k}^{( B )} . \\ \text{?} \text{indicates text missing or illegible when filed} \qquad [ Expression 9 ]$$

Optimal Pseudo-Deadline Assignment

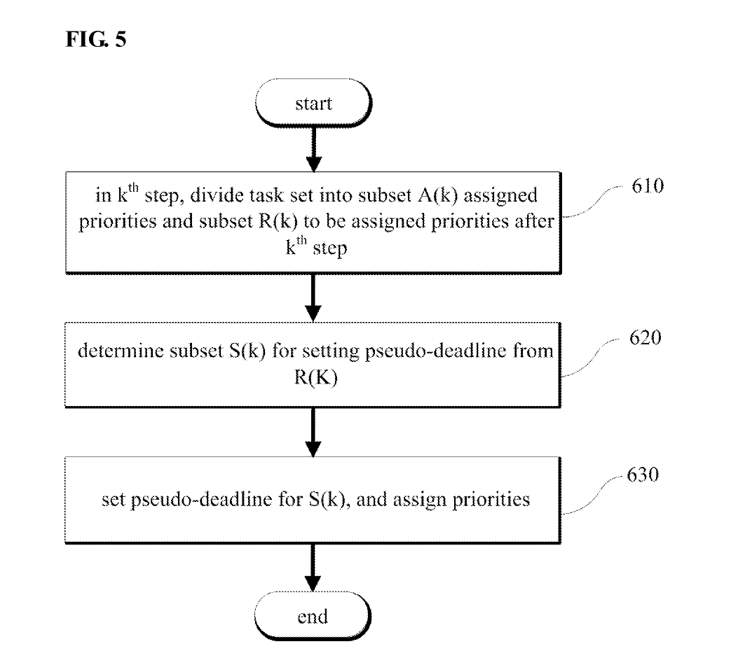

FIG. 5 is an example of a flowchart of a method of assigning priorities to tasks using pseudo-deadlines in a multiprocessor apparatus.

A method of assigning priorities to tasks using pseudo-deadlines in a multiprocessor apparatus includes, in a k^{th} step, dividing a task set into a subset A(k) assigned priorities and a subset R(k) to be assigned priorities after the k^{th} step (610), determining a subset S(k) for setting a pseudo-deadline from R(K) (620), and setting a pseudo-deadline for S(k), and assigning the priorities (630). Detailed description will be made below.

The present invention is aimed to determine a relative pseudo-deadline Pᵢ of each task τᵢ of a certain task set τ (τᵢετ) such that the task set τ is scheduled according to the SPDF schedulability test given in Theorem 2 described above.

First, an optical priority assignment (OPA) algorithm for TFP scheduling will be briefly described, and it will be examined whether it is possible to expand the OPA algorithm to JFP scheduling. Lastly, an optimal pseudo-deadline assignment (OPDA) algorithm of applying the OPA algorithm to a pseudo-deadline of the present invention will be described.

1) TFP/OPA: The OPA algorithm (R. Davis and A. Burns, “Priority assignment for global priority pre-emptive scheduling in multiprocessor real-time systems,” in RTSS, 2009.) assigns a priority to each individual task through iterative priority assignment such that a whole task set τ can be scheduled.

In a k^{th} iteration step, the task set τ is divided into two disjoint subsets A(k) and R(k). A(k) is a subset of tasks whose priorities have been assigned before the k^{th} step, and R(k) is a subset of remaining tasks whose priorities will be assigned after the k^{th} step.

A task τₑ is TFP-eligible in the k^{th} step when τₑ is schedulable under the assumption that τₑ is strictly higher than all the tasks τₐεA(k) assigned priorities (τₑ [symbol] τᵣ) but strictly lower than all the remaining tasks τᵣεR(k) (τₑ [symbol] τᵣ). In the k^{th} step, OPA selects one of the tasks eligible for priority assignment. For simple description, notations as follows will be introduced.

E(k) denotes a subset of tasks that can be selected in the k^{th} step, and S(k) denotes a subset of tasks selected for priority assignment in the k^{th} step (S(k) c E(k)).

TFP/OPA has the following characteristics. First, the most important characteristic is that the algorithm gradually progresses without back-tracking. Even when a task τₛ is selected in an iterative k^{th} step, the task τₛ has no effect on priority assignment in the next iterative (k+1)^{th} step. This is because the task τₛ is assigned a priority strictly lower than all the remaining tasks τᵣεR(k). Second, assuming that only one task τₑ is eligible in the k^{th} step, OPA should search all the remaining tasks R(k) for the one eligible task τₑ. Third, assuming that a plurality of tasks are eligible in the k^{th} step, it does not matter which eligible task is selected in the k^{th} step. This is because all the other eligible tasks will remain eligible even in other steps and will be eventually selected for priority assignment in a subsequent step.

2) Applicability of OPA to JFP: It will be examined whether the OPA algorithm can be applied to JFP. A key difference between TFP and JFP is that Type B (mutual relationship) is effective in JFP only. OPA was designed for TFP, and thus does not consider Type B relationship in the process of priority assignment. Thus, to extend OPA to JFP, the problem of Type B should be solved.

For description, it is assumed that there is no TFP-eligible task in the k^{th} step. Under the assumption that each task τⱼεR(k) has Type A1 relationship with all the other remaining tasks, priority assignment for scheduling cannot be performed on τⱼ. This is given as an expression below.

$$∀ {τ}_{j} ∈ R ( k ) , {\sum }_{{τ}_{r} ∈ R ( k ) , r \neq j}^{ } {I}_{r , j}^{( A 1 )} > m ( {D}_{j} - {C}_{j} + 1 )$$

It is assumed that there is a pair of tasks τₚ and τ_{q} scheduled only when they have Type B relationship. This can be given as an expression below.

$${\sum }_{{τ}_{r} ∈ R ( k ) , r \neq p , r \neq q}^{ } {I}_{r , p}^{( A 1 )} + {I}_{q , p}^{( B )} \leq m ( {D}_{p} - {C}_{p} + 1 ) , \\ and$$

$${\sum }_{{τ}_{r} ∈ R ( k ) , r \neq p , r \neq q}^{ } {I}_{r , p}^{( A 1 )} + {I}_{p , q}^{( B )} \leq m ( {D}_{q} - {C}_{q} + 1 ) ,$$

Even in this case, it may be possible to assign job-level priorities to the two tasks τₚ and τ_{q} that are schedulable. However, OPA finds only one task in each iterative step, and thus priority assignment is impossible.

As a result, while JFP can support tasks having Type B relationship, TFP can support only tasks having Type A relationship. This motivates the design of a new priority assignment algorithm for JFP scheduling as will be described below.

3) OPDA algorithm: OPDA whereby the TFP/OPA algorithm is expanded to JFP is described now. OPDA iteratively performs pseudo-deadline assignment according to a basic algorithm of OPA (Algorithm 1 and Algorithm 2).

ALGORITHM 1
Optimal Pseudo-Deadline Assignment

| Require: k ← 0, Z^{H} (1) ← 0, R(1) ← τ | |
|---|---|
| 1: | repeat |
| 2: | k ← k + 1 |
| 3: | for each i in {1, . . . , \|R(k)\|} do |
| 4: | if FIND-SUBSET (k, i) = success then |
| 5: | break (continue outer loop) |
| 6: | end if |
| 7: | end for |
| 8: | return unschedulable |
| 9: | until R(k) is empty |
| 10: | return schedulable |

In each iterative k^{th} step, OPDA divides a task set τ into two disjoint sets A(k) and R(k). Enforced Type A relationship between A(k) and R(k) allows OPDA also to gradually solve a problem (gradually assign priorities) as TFP/OPA. On the other hand, main differences between TFP/OPA and OPDA lie in a method of establishing Type A relationship between A(k) and R(k), and a method of selecting S(k) for pseudo-deadline assignment in the k^{th} step.

For gradual priority assignment, it is important to establish Type A relationship between A(k) and R(k). In case of TFP, Type A relationship is easily established between the two subsets by assigning different priorities to different tasks. On the other hand, in case of JFP, a different method of separating the two subsets is necessary to establish Type A relationship.

Under SPDF scheduling, when two tasks satisfy the condition necessary for Lemma 1 described above, the two tasks have Type A relationship. Thus, it is possible to establish Type A relationship between A(k) and R(k) by assigning relative pseudo-deadlines such that all tasks τₐ belonging to A(k) and all tasks τᵣ belonging to R(k) satisfy Pₐ≦Pᵣ−Dᵣ.

In addition, OPDA establishes Type B relationship in the process of pseudo-deadline assignment. Unlike TFP/OPA that assigns a priority to one task in each iterative step, OPDA searches a plurality of different tasks to determine S(k), and enforces Type B relationship between tasks in the subset S(k).

As described in Algorithm 1 above, OPDA iteratively finds a subset S(k) in each k^{th} step until there is no more remaining task. In each k^{th} step, a function FIND-SUBSET(k, i) is executed to find the subset S(k) of a smallest size i.

ALORITHM 2
FIND-SUBSET (k, i)

| | |
|---|---|
| 1: | [symbol] ← a set of all i-combinations of R(k) |
| 2: | for each combination S(k) in [symbol] do |
| 3: | maxD(k) ← max{Dₛ} for all τₛ ∈ [symbol] (k) |
| 4: | sumD(k) ← Σ Dₛ for all τₛ ∈ [symbol] (k) |
| 5: | Z^{L} (k + 1 ) ← Z^{H} (k) + sumD(k) |
| 6: | Z^{H} (k + 1 ) ← Z^{L} (k + 1) + maxD(k) |
| 7: | [symbol] ← R(k)\S(k) |
| 8: | for each task τᵣ ∈ [symbol] do |
| 9: | Pᵣ ← Z^{H} (k + 1) |
| 10: | end for |
| 11: | [symbol] ← a set of all i-permutations with repetition from a set |
| | {Z^{H} (k), Z^{H} (k) − 1, . . . , Z^{L} (k + 1 ) + 1, Z^{L} (k + 1)} |
| 12: | for each element < p₁, p₂, . . . , pₖ > in [symbol] do |
| 13: | j ← 1 |
| 14: | for each task τₛ ∈ S(k) do |
| 15: | Pₛ ← pⱼ |
| 16: | j ← j + 1 |
| 17: | end for |
| 18: | if an entire task set τ is deemed schedulable according |
| | to schedulability test X then |
| 19: | R(k + 1) ← R(k)\S(k) |
| 20: | return success |
| 21: | end if |
| 22: | end for |
| 23: | end for |
| 24: | return fail |

As described in Algorithm 2 above, FIND-SUBSET(k, i) considers a set S(k) of combinations of all tasks having the size i from all the remaining tasks R(k).

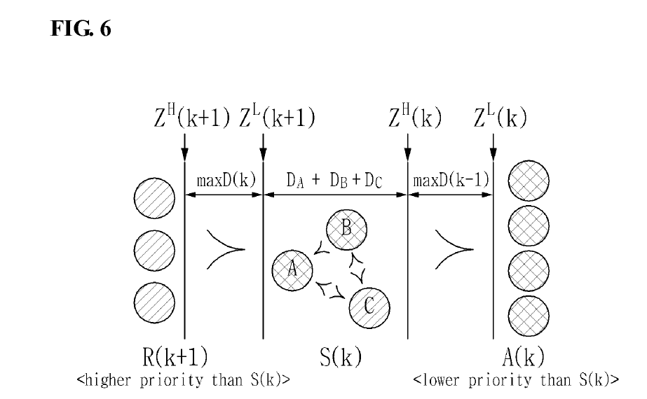

FIG. 6 illustrates an example of a buffer zone in a k^{th} step of OPDA. As shown in FIG. 6, under the assumption that tasks belonging to S(k) having the size i have Type A1 relationship with each task belonging to A(k), and tasks belonging to S(k) have Type A or Type B relationship with each other, and have Type A2 relationship with the remaining tasks belonging to R(k), each combination of the tasks belonging to S(k) having the size i can be scheduled according to Theorem 2 described above.

To enforce Type A relationship between A(k) and R(k), OPDA employs a pseudo-deadline buffer zone [Z^{H}(k), Z^{L}(k)] between A(k) and R(k). Accordingly, no task is assigned a pseudo-deadline in the buffer zone (lines 3 to 6 in Algorithm 2).

$${Z}^{L} ( k ) - {Z}^{H} ( k ) = {max}_{{τ}_{r} ∈ A ( k )} {D}_{r} \text{?} max D ( k )$$

$${Z}^{H} ( k ) - {Z}^{L} ( k + 1 ) = {\sum }_{{τ}_{r} ∈ R ( k )}^{ } {D}_{r} \text{?} sum D ( k )$$

$$\text{?} \text{indicates text missing or illegible when filed}$$

According to the principle of Type A relationship described in Lemma 1, all the assigned tasks τₐεA(k) have earlier (numerically greater) pseudo-deadlines than Z^{L}(k), and the remaining tasks τᵣεR(k+1) have later (numerically smaller) pseudo-deadlines than Z^{H}(k+1) (lines 8 and 9 of Algorithm 2).

A buffer zone size maxD(k) is large enough to separate A(k) and R(k) under Type A relationship. OPDA assigns possible pseudo-deadlines to all the eligible tasks τₛεS(k) within [Z^{L}(k+1), Z^{H}(k)] (lines 11 to 22 in Algorithm 2).

When the algorithm succeeds in finding a task subset having the size i, the algorithm proceeds to the next iterative step. On the other hand, when the algorithm fails to find a task subset having the size i, the algorithm searches a combination of subsets greater by one size for a schedulable task subset. The algorithm tries to find a subset satisfying the condition while increasing a size of the subset by one at a time.

Theorem 3: The OPDA algorithm is a technique of assigning optimal pseudo-deadlines for the SPDF schedulability test of Theorem 2. A proof of this is provided in the paper written by the inventor.

The above-described technology assigns pseudo-deadlines to real-time tasks, and performs scheduling and applies real-time property analysis techniques using the assigned pseudo-deadlines such that the real-time property analysis techniques only applicable to the TFP scheduling algorithm can also be applied to the JFP scheduling algorithm.

In addition, the above-described technology ensures much better performance than existing real-time techniques using a method of optimally setting pseudo-deadlines.

Furthermore, while an OPDA method has the drawback of high time complexity, the above-described technology has much lower time complexity through a heuristic assignment method compared with the OPDA method, but shows similar performance.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A scheduling method in a multiprocessor, comprising:
releasing tasks;
setting relative pseudo-deadlines for the tasks such that jobs belonging to one task τₐ among the tasks always have higher priorities than jobs belonging to another task τ_{b}, and determining task priorities; and
setting absolute pseudo-deadlines for jobs belonging to the tasks, and determining job priorities.

2. The scheduling method of claim 1, wherein the determining of the task priorities includes setting the relative pseudo-deadlines such that τₐ and τ_{b} satisfy Pₐ≦P_{b}−D_{b} (where Pₐ is a relative pseudo-deadline for τₐ, P_{b} is a relative pseudo-deadline for τ_{b}, and D_{b} is a relative deadline for τ_{b}).

3. The scheduling method of claim 2, wherein the relative pseudo-deadlines are intervals between times at which the jobs belonging to the tasks are released and the absolute pseudo-deadlines for the jobs, and
the relative deadline is an interval between a time at which one job is released and an absolute deadline for the job.

4. The scheduling method of claim 1, wherein the determining of the job priorities includes calculating an absolute pseudo-deadline pᵢ^{h} for an h^{th} job Jᵢ^{h} of the tasks τᵢ as pᵢ^{h}=rᵢ^{h}+Pᵢ, and assigning a highest priority to a job having a smallest (where rᵢ^{h} is a time at which Jᵢ^{h} is released, and Pᵢ is a relative deadline for τᵢ).

5. The scheduling method of claim 1, wherein, in the determining of the task priorities, τᵢ and τₖ that are different tasks among the tasks satisfy an interference condition of an expression below on a multiprocessor including m identical processors:
$$\text{?} {I}_{i , k}^{SPDF} < m \cdot ( {D}_{k} - {C}_{k} + 1 )$$
$$\text{?} \text{indicates text missing or illegible when filed}$$
(where I_{i,k}^{SPDF} is interference between the tasks τᵢ and τₖ, Dₖ is a relative deadline for the task τₖ, and Cₖ is a worst-case execution time of the task τₖ).

6. A method of assigning priorities to tasks using pseudo-deadlines in a multiprocessor apparatus, comprising:
in a k^{th} step, dividing a task set into a subset A(k) assigned priorities and a subset R(k) to be assigned priorities after the k^{th} step;
determining a subset S(k) for setting a pseudo-deadline from R(K); and
setting a pseudo-deadline for S(k), and assigning the priorities.

7. The method of claim 6, wherein a task τₐ belonging to A(k) and a task τᵣ belonging to R(k) satisfy Pₐ≦Pᵣ−Dᵣ such that jobs belonging to τₐ have higher priorities than jobs belonging to τᵣ (where Pₐ is a relative pseudo-deadline for τₐ, Pᵣ is a relative pseudo-deadline for τᵣ, and Dᵣ is a relative deadline for τᵣ).

8. The method of claim 6, wherein the determining of S(k) includes examining all combinations of tasks belonging to R(k), and determining S(k) such that all jobs of tasks belonging to S(k) have higher priorities than jobs of tasks belonging to A(k), and the jobs of the tasks belonging to S(k) have lower priorities than jobs of tasks remaining in R(k).

9. The method of claim 6, wherein a buffer zone [Z^{H}(k), Z^{L}(k)] is in a time period between A(k) and R(k), and
no pseudo-deadline is assigned in the buffer zone.

10. The method of claim 6, wherein, in the determining of S(k), τᵢ and τₖ that are different tasks among tasks belonging to S(k) satisfy an interference condition of an expression below on a multiprocessor including m identical processors:
$$\text{?} {I}_{i , k}^{SPDF} < m \cdot ( {D}_{k} - {C}_{k} + 1 )$$
$$\text{?} \text{indicates text missing or illegible when filed}$$
(where I_{i,k}^{SPDF} is interference between the tasks τᵢ and τₖ, Dₖ is a relative deadline for the task τₖ, and Cₖ is a worst-case execution time of the task τₖ).
